(19) United States
(12) Patent Application Publication
(10) Pub. No.: US 2015/0142662 A1
(43) Pub. Date: May 21, 2015

(54) SYSTEMS AND METHODS FOR IDENTIFICATION VERIFICATION USING ELECTRONIC IMAGES

(71) Applicant: First Data Corporation, Greenwood Village, CO (US)

(72) Inventor: Sean Richard Crabson, Aurora, CO (US)

(21) Appl. No.: 14/549,059

(22) Filed: Nov. 20, 2014

Related U.S. Application Data
(60) Provisional application No. 61/906,476, filed on Nov. 20, 2013.

(51) Int. Cl. G06Q 20/40; G06T 7/00; G06K 9/00

(52) U.S. Cl. CPC G06Q 20/40; G06K 9/00885; G06T 7/0002
USPC 705/44

(57) ABSTRACT

Systems and methods are provided for identification verification using electronic images. For instance, a method may include receiving, by a computer from a service provider computer, a notification indicating that a user has failed electronic verification. The method may also include receiving, by the computer from the service provider computer, instructions to transmit identification data associated with the user. Additionally, the method may include generating an electronic image of an identification document associated with the user and transmitting the electronic image to the service provider computer for verification of the user

### CROSS-REFERENCE TO RELATED APPLICATION

This application claims the benefit of U.S. Provisional Application No. 61/906,476, filed Nov. 20, 2013, entitled “System and Methods for Identification Verification Using Electronic Images,” the contents of which are hereby incorporated by reference.

### FIELD OF THE DISCLOSURE

The disclosure generally relates to identification verification, and more particularly relates to systems and methods for identification verification using electronic images.

### BACKGROUND

Consumers who wish to access financial services of financial institutions may be required to verify their identities pursuant to certain laws, such as the United States' Patriot Act. In some instances, the financial institution may perform electronic verification of a user's identity, by requesting the user's name, address, date of birth, and/or identification number, such as a U.S. Social Security number. If the user fails electronic verification (e.g., the user is unable to accurately provide at least a predefined number of requested data items), the financial institution may request that the user provide documentary verification of his or her identify. Such documentary verification may include a driver's license, birth certificate, military identification, identification card such as a U.S. Social Security card, and/or other types of document identification.

In certain cases, the user may transmit photocopies and/or facsimiles of these documents to the financial institution for verification. These photocopies and/or facsimiles may vary in quality, which may present difficulties in the verification process.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example system for identification verification in accordance with one or more example embodiments.

FIG. 2 illustrates a block diagram of an example data flow for identification verification in accordance with one or more example embodiments.

FIG. 3 illustrates a flow diagram of an example method for identification verification in accordance with one or more example embodiments.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like, but not necessarily the same or identical, elements throughout. Hence, if a feature is used across several drawings, the number used to identify the feature in the drawing where the feature first appeared will be used in later drawings.

### DETAILED DESCRIPTION

### Overview

Described herein are systems and methods for identification verification using electronic images. Broadly, the systems and methods described herein may facilitate the image capture of one or more identification documents in order to very identify of a user of a service provided by a service provider.

Thus, according to one or more embodiments of the disclosure, a method is provided for identification verification. The method may include receiving, by a computer including one or more processors, a notification indicating that a user has failed electronic verification. The method may also include receiving, by the computer from the service provider computer, instructions to transmit identification data associated with the user. Furthermore, the method may include generating, by the computer, an electronic image of an identification document associated with the user. Additionally, the method may include transmitting the electronic image to the service provider computer for verification of the user.

According to one or more other embodiments of the disclosure, a device is provided. The device may include at least one memory for storing data and computer-executable instructions. The device may also include at least one processor to access the at least one memory and to execute the computer-executable instructions. The at least one processor may be configured to execute the instructions to receive from a service provider computer, a notification indicating that a user has failed electronic verification. The at least one processor may also be configured to execute the instructions to receive instructions to transmit identification data associated with the user. The at least one processor may further be configured to execute the instructions to generate an electronic image of an identification document associated with the user. Additionally, the at least one processor may further be configured to execute the instructions to transmit the electronic image to the service provider computer for verification of the user.

According to one or more other embodiments of the disclosure, another method is provided for identification verification. The method may include receiving, by a service provider computer from a user device, identification information to access an account associated with a user of the user device. The method may also include determining that the identification information is insufficient to pass identification verification of the user. Furthermore, the method may include transmitting, to the user device, a request for an identification document and receiving, from the user device in response to the request, an electronic image of the identification document. Additionally, the method may include extracting document data associated with the electronic image of the identification document and determining, based at least in part on the extracted document data, whether an identity of the user is verified.

These and other embodiments of the disclosure will be described in more detail through reference to the accompanying drawings in the detailed description of the disclosure that follows. This brief introduction, including section titles and corresponding summaries, is provided for the reader's convenience and is not intended to limit the scope of the claims or the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Illustrative Embodiments

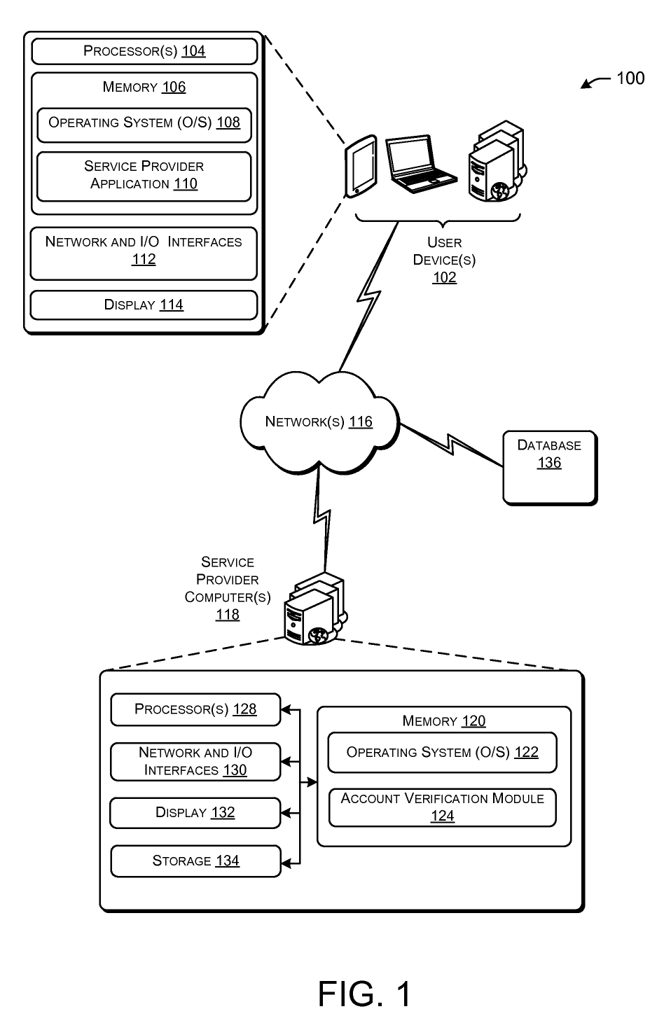

With reference now to FIG. 1, a system 100 for identification verification is shown according to one or more embodiments of the disclosure. The system 100 may include one or more user device(s) 102. In general, the user device 102 may refer to any type of electronic device, and, more particularly, may refer to one or more of the following: a wireless communication device, a portable electronic device, a telephone (e.g., cellular phone, smart phone), a computer (e.g., laptop computer, tablet computer), a wearable computer device, a portable media player, a personal digital assistant (PDA), or any other electronic device having a networked capability. The user device(s) 102 may include one or more computer processors 104, and a memory 106 storing an operating system 108 and a service provider application 110. In addition, the user device(s) 102 may include a, network and I/O interfaces 112, and a display 114. In certain embodiments, the user device(s) 102 may include one or more sensors capable of gathering information associated with a present environment of the user device(s) 102, or similar hardware devices, such as a camera, microphone, antenna, a gesture capture or detection device, or Global Positioning Satellite (GPS) device.

The computer processors 104 may comprise one or more cores and may be configured to access and execute (at least in part) computer-readable instructions stored in the memory 106. The one or more computer processors 104 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The user device 102 may also include a chipset (not shown) for controlling communications between the one or more processors 104 and one or more of the other components of the user device 102. In certain embodiments, the user device 102 may be based on an Intel® architecture or an ARM® architecture, and the processor(s) and chipset may be from a family of Intel® processors and chipsets. The one or more processors 104 may also include one or more application-specific integrated circuits (ASICs) or application-specific standard products (ASSPs) for handling specific data processing functions or tasks.

The memory 106 may include one or more computer-readable storage media (CRSM). In some embodiments, the memory 106 may include non-transitory media such as random access memory (RAM), flash RAM, magnetic media, optical media, solid state media, and so forth. The memory 106 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 106 may store an operating system 108 that includes a plurality of computer-executable instructions that may be implemented by the computer processor to perform a variety of tasks to operate the interface(s) and any other hardware installed on the user device 102. The memory 106 may also store content that may be displayed by the user device 102 or transferred to other devices (e.g., headphones) to be displayed or played by the other devices. The memory 106 may also store content received from the other devices. The content from the other devices may be displayed, played, or used by the user device 102 to perform any necessary tasks or operations that may be implemented by the computer processor or other components in the user device 102.

The network and I/O interfaces 112 may also include one or more communication interfaces or network interface devices to provide for the transfer of data between the user device 102 and another device (e.g., network server) via a network (not shown). The communication interfaces may include, but are not limited to: personal area networks (PANs), wired local area networks (LANs), wireless local area networks (WLANs), wireless wide area networks (WWANs), and so forth. The user device 102 may be coupled to the network via a wired connection. However, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2007, published Mar. 8, 2007; IEEE 802.11n-2009, published October 2009), or a combination thereof. The wireless system (not shown) may include a transmitter and a receiver or a transceiver (not shown) capable of operating in a broad range of operating frequencies governed by the IEEE 802.11 wireless standards. The communication interfaces may utilize acoustic, radio frequency, optical, or other signals to exchange data between the user device 102 and another device, such as an access point, a host computer, a server, a router, a reader device, and the like. The network may include, but is not limited to, the Internet, a private network, a virtual private network, a wireless wide area network, a local area network, a metropolitan area network, a telephone network, and so forth.

The display 114 may include, but is not limited to, a liquid crystal display, a light-emitted diode display, or other suitable display or output-type device. The display 114 may be used to show content to a user in the form of text, images, or video. In certain instances, the display 114 may also operate as a touch screen display that may enable the user to initiate commands or operations by touching the screen using certain finger or hand gestures.

The user device(s) 102 may also be in communication with one or more service provider computer(s) 118, such as via a network 116. The service provider computer(s) 118 may include one or more processor(s) 128 and at least one memory 120, which may store an operating system 122, and a account verification module 124. Furthermore, the service provider computer(s) 118 may include network and I/O interfaces 130, a display 132, and storage 134. In some implementations, the service provider computer(s) 118 may be associated with one or more financial institutions and/or financial systems.

Furthermore, as shown in the embodiment of FIG. 1, a database 136 can be accessible by the user devices 102 and/or service provider computers 118 via the network(s) 116. The database 136 can include any type of data storage device and/or any number of data storage devices.

According to one or more example embodiments, the service provider application 110 may be configured to interface with a user and provide financial services to the user. For instance, the service provider application 110 may be associated with a service provider, such as a financial institution (e.g., a bank, credit union, etc.), and may be in communication with one or more service provider computer(s) 118. As such, the service provider application 110 may enable the user to access information and/or services associated with an account with the service provider. For example, the service provider application 110 may enable the user to review account balances, make payments, transfer funds between accounts, and/or provide the user with any other type of financial service.

In certain implementations, in order for the user to access the financial services of the service provider application 110 with respect to a certain account, the service provider application 110 may require the user to electronically verify the user's identification. To this end, the account verification module 124 of the service provider application 110 may request that the user provide the user's name, address, date of birth, identification number such as a U.S. Social Security Number, and/or any other type of identification information. Upon receipt of the supplied identification information, the account verification module 124 and/or operator(s) of the service provider computer(s) 118 may access the database 136 to determine stored account identification information associated with the account. The account verification module 124 and/or the operator(s) may compare the supplied identification information with the stored account identification information. In certain instances, the service provider computer(s) 118 (e.g., at the direction of the service provider) may designate a threshold for determining, based at least in part on the comparison, whether the user has passed electronic verification. For example, the service provider computer(s) 118 may determine that in order to pass electronic verification, some or all of the user's supplied identification information must match the stored account identification information in the database 136. Alternatively, the service provider computer(s) 118 may set the threshold such that a certain percentage or predefined number of the user's supplied identification information must match the stored account identification information in the database 136.

In certain example embodiments, the account verification module 124 and/or the operator(s) may determine that the user has failed electronic verification. To this end, the service provider computer(s) 118 may be configured to transmit a notification and/or any other type of indication of the failure to the service provider application 110 on the user device 102. In addition to the notification, or alternatively as part of the notification, the service provider computer(s) 118 may be configured to transmit a request (e.g., an electronic request) for one or more photocopies of certain identification document(s) of the user. Such identification documents may include, but are not limited to, a driver's license, a social security card, a birth certificate, a military identification card, a passport, and/or any other type of identification. In other embodiments, service provider computer(s) 118 may not transmit such a request to the user device 102. Instead, the service provider application 110 may be configured to, in response to receipt of the notification of electronic verification failure, request such identification document directly from the user such as via mail, a phone call, and/or the like.

As such, the service provider application 110 may prompt the user to generate, upload, download, and/or otherwise provide the service provider application 110 with a copy, such as a photocopy or other electronic image, of one or more identification documents. In some implementations, the user device 102 may include an image capturing device (not pictured) such as a camera, a video camera, etc. To this end, the service provider application 110 may be configured to access the image capturing device and prompt the user capture an image (e.g., picture, video, etc.) of the identification document(s). Once an image has been captured, the service provider application 110 may be configured to transmit the image back to the service provider computer(s) 118. Alternatively, the service provider application 110 may be configured to receive an upload and/or download of an image of the identification document(s), such as from another device.

Upon receipt of the image(s) of the identification document(s), the service provider computer(s) 118 may be configured to verify information associated with the identification document(s). For example, the service provider computer(s) 118 may be configured to perform one or more transformation-type processes and/or techniques, such as performing optical character recognition (OCR) on the image(s) to determine certain identification information associated with the user (e.g., name, date of birth, gender, height, weight, address, phone number, driver's license number, social security number, military ID number, identification number, etc.). Alternatively, an operator of the service provider computer(s) 118 may manually look at the image(s) and enter such identification information into the service provider computer(s) 118. In either case, the identification information may be compared with the stored account identification information in the database 136 to verify the user's identity.

In certain implementations, depending on the quality of the image captured, the service provider application 110 and/or the service provider computer(s) 118 may be configured to determine whether to request another image of the identification document(s) to be captured. For example, if the service provider computer 118 is unable to extract certain identification information (e.g., name, date of birth, etc.) from the provided image, the serviced provider computer 118 may transmit a request to the user device 102 request another image of the identification document(s) to be captured.

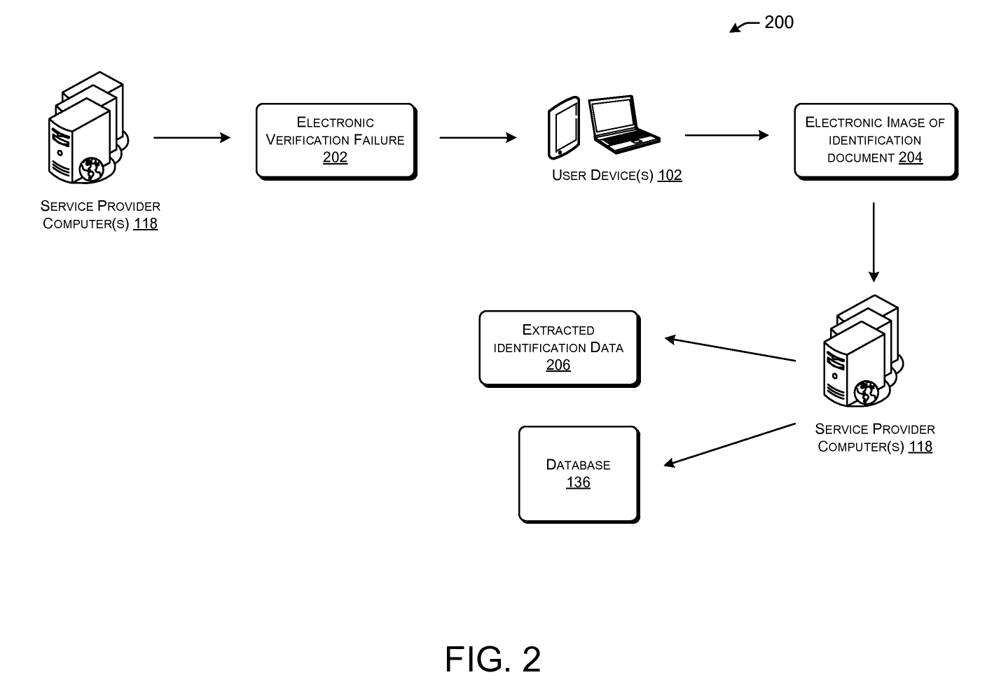

Turning now to FIG. 2, a diagram of a data flow 200 is illustrated for identification verification in accordance with one or more example embodiments. As depicted, the service provider computers 118 may be configured to transmit, to the user device, a message indicating electronic verification failure 202 for a particular user. In response, the user device 102 may be configured to generate and/or otherwise access an electronic image of an identification document 204 associated with the user. The user device 102 may further be configured to transmit the image 204 to the service provider computer 118. Upon receipt of the image 204, the service provider computer 118 may be configured to extract identification data 206 from the image 204. Furthermore, the service provider computer 118 may be configured to access, from the database 136 stored account identification data associated with the user and compare the stored account identification data with the extracted identification data 206 to verify the identity of the user.

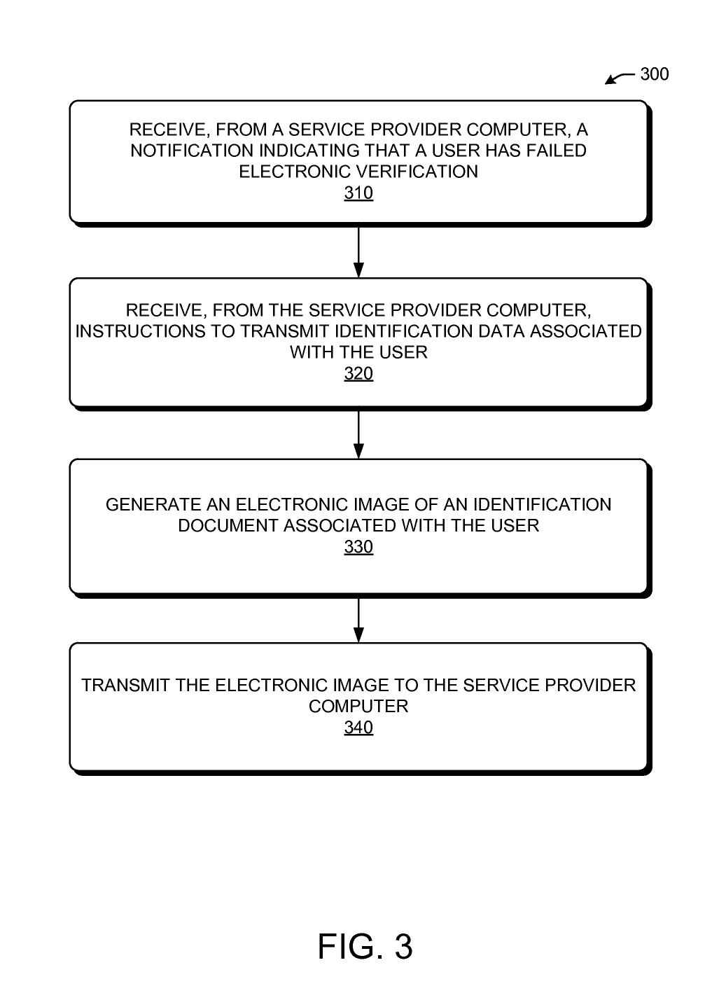

Turning now to FIG. 3, a flow diagram of a method 300 for identification verification is illustrated according to one or more example embodiments. The method 300 can be implemented with some or all of the system components described with respect to system 100 in FIG. 1. The method 300 may include block 310, in which a computer, such as a user device 102, may receive and/or otherwise access, from a service provider computer 118, a notification indicating that a user has failed electronic verification. In block 320, the user device 102 may receive, from the service provider computer 118, instructions to transmit identification data associated with the user. In block 330, the user device 102 may generate an electronic image of an identification document associated with the user. In block 340, the user device 102 may transmit the electronic image to the service provider computer 118 for verification of the user.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

1. A method, comprising:
receiving, by a computer comprising one or more processors from a service provider computer, a notification indicating that a user has failed electronic verification;
receiving, by the computer from the service provider computer, instructions to transmit identification data associated with the user;
generating, by the computer, an electronic image of an identification document associated with the user; and
transmitting the electronic image to the service provider computer for verification of the user.

2. The method of claim 1, further comprising:
determining whether an image quality associated with the electronic image is below a predetermined quality threshold; and
generating, upon a determination that the image quality is below the predetermined quality threshold, a second electronic image of the identification document.

3. The method of claim 1, further comprising:
receiving, from the service provider computer, a request to provide another electronic image of the identification document; and
generating, in response to the request, a second electronic image of the identification document.

4. The method of claim 1, wherein the identification document comprises at least one of a driver's license, social security card, birth certificate, passport, or military identification card.

5. The method of claim 1, further comprising:
receiving, from the service provider computer, an indication of whether an identity of the user is verified based at least in part on document data extracted from the electronic image.

6. The method of claim 1, wherein the document data comprises information associated with at least one of a name, date of birth, gender, height, weight, address, phone number, driver's license number, social security number, or military identification number.

7. The method of claim 1, wherein generating the electronic image of the identification document comprises taking a picture of the identification document.

8. A device, comprising:
at least one processor;
at least one memory storing computer-executable instructions, that when executed by the at least one processors, cause the at least one processor to:
receive, from a service provider computer, a notification indicating that a user has failed electronic verification;
receive instructions to transmit identification data associated with the user;
generate an electronic image of an identification document associated with the user; and
transmit the electronic image to the service provider computer for verification of the user.

9. The device of claim 8, wherein the computer-executable instructions further cause the at least one processor to:
determine whether an image quality associated with the electronic image is below a predetermined quality threshold; and
generate, upon a determination that the image quality is below the predetermined quality threshold, a second electronic image of the identification document

10. The device of claim 8, wherein the computer-executable instructions further cause the at least one processor to:
receive, from the service provider computer, a request to provide another electronic image of the identification document; and
generate, in response to the request, a second electronic image of the identification document.

11. The device of claim 8, wherein the identification document comprises at least one of a driver's license, social security card, birth certificate, passport, or military identification card.

12. The device of claim 8, wherein the computer-executable instructions further cause the at least one processor to:
receiving, from the service provider computer, an indication of whether an identity of the user is verified based at least in part on document data extracted from the electronic image.

13. The device of claim 8, wherein the document data comprises information associated with at least one of a name, date of birth, gender, height, weight, address, phone number, driver's license number, social security number, or military identification number.

14. The device of claim 8, wherein the computer-executable instructions to generate the electronic image of the identification document further comprises instructions to generate a picture of the identification document via a camera coupled to the at least one processor.

15. A non-transitory computer-readable medium comprising computer-executable instructions, that when executed by at least one processor, causes the at least one processor to:
receive, from a service provider computer, a notification indicating that a user has failed electronic verification;
receive instructions to transmit identification data associated with the user;
generate an electronic image of an identification document associated with the user; and
transmit the electronic image to the service provider computer for verification of the user.

16. The computer-readable medium of claim 15, wherein the computer-executable instructions further cause the at least one processor to:
determine whether an image quality associated with the electronic image is below a predetermined quality threshold; and
generate, upon a determination that the image quality is below the predetermined quality threshold, a second electronic image of the identification document

17. The computer-readable medium of claim 15, wherein the computer-executable instructions further cause the at least one processor to:
receive, from the service provider computer, a request to provide another electronic image of the identification document; and
generate, in response to the request, a second electronic image of the identification document.

18. The computer-readable medium of claim 15, wherein the identification document comprises at least one of a driver's license, social security card, birth certificate, passport, or military identification card.

19. The computer-readable medium of claim 15, wherein the computer-executable instructions further cause the at least one processor to:
receiving, from the service provider computer, an indication of whether an identity of the user is verified based at least in part on document data extracted from the electronic image.

20. The computer-readable medium of claim 15, wherein the document data comprises information associated with at least one of a name, date of birth, gender, height, weight, address, phone number, driver's license number, social security number, or military identification number.
